(19) United States
(12) Patent Application Publication
(10) Pub. No.: US 2026/0284572 A1
(43) Pub. Date: Sep. 24, 2026

(54) DAC APPARATUS

(71) Applicant: Honda Motor Co., Ltd., Tokyo (JP)

(72) Inventors: Gou Tamura, Saitama (JP); Hiroka Shigi, Saitama (JP)

(21) Appl. No.: 19/567,100

(22) Filed: Mar. 14, 2026

(30) Foreign Application Priority Data
Mar. 19, 2025 (JP) 2025-045895

(51) Int. Cl. B01D 53/04

(52) U.S. Cl. CPC B01D 53/0446; B01D 53/0454; B01D 2257/504; B01D 2257/80

(57) ABSTRACT

DAC apparatus to recover CO₂ in the atmosphere, includes: an adsorption chamber provided with an adsorbent for absorbing CO₂ and water; an atmospheric control valve to open the adsorption chamber to the atmosphere or seal the adsorption chamber from the atmosphere; a vacuum pump connected with the adsorption chamber through vacuum piping; a vacuum control valve provided on the vacuum piping; and a controller to alternately perform an adsorption step and desorption step, the adsorption step opening the adsorption chamber to the atmosphere, prohibiting flow of gas to the vacuum piping, and adsorbing CO₂ in the atmosphere, the desorption step sealing the adsorption chamber, permitting flow of gas to the vacuum piping, and desorbing CO₂ from the adsorbent. The controller sets a target rotation speed of a motor that drives the vacuum pump based on an amount of water adsorbed, and controls the motor according to the target rotation speed.

### CROSS-REFERENCE TO RELATED APPLICATION

This application is based upon and claims the benefit of priority from Japanese Patent Application No. 2025-045895 filed on March 19, 2025, the content of which is incorporated herein by reference.

### BACKGROUND OF THE INVENTION

### Field of the Invention

The present invention relates to a direct air capture (DAC) apparatus that recovers carbon dioxide (CO₂) in the atmosphere.

### Description of the Related Art

For the purpose of mitigating climate changes, research and development have been conducted on DAC technology for recovering CO₂, which is a main greenhouse gas. As such a DAC technology, an apparatus that recovers CO₂ in the atmosphere using an adsorbent for adsorbing or absorbing CO₂ is known. For example, in the apparatus of JP 2024-048937 A, after the atmosphere is caused to circulate into an adsorption chamber in which an adsorbent is provided and to adsorb CO₂ in the atmosphere to the adsorbent, the adsorbent is heated to desorb CO₂ from the adsorbent. When the pressure in the adsorption chamber reaches a threshold value, a vacuum pump is switched from off to on to recover a desorption gas having a high CO₂ concentration from the inside of the adsorption chamber.

However, as in the apparatus described in JP 2024-048937 A, by merely switching between on and off of the vacuum pump, it is difficult to efficiently operate the vacuum pump for CO₂ recovery.

### SUMMARY OF THE INVENTION

An aspect of the present invention is a DAC apparatus configured to recover CO₂ in the atmosphere, including: an adsorption chamber provided with an adsorbent for adsorbing or absorbing CO₂ and water; an atmospheric control valve configured to open the adsorption chamber to the atmosphere or seal the adsorption chamber from the atmosphere; a vacuum pump including an intake port connected with the adsorption chamber through a vacuum piping; a vacuum control valve provided on the vacuum piping; and a controller configured to control the atmospheric control valve and the vacuum control valve to alternately perform an adsorption step and a desorption step, the adsorption step opening the adsorption chamber to the atmosphere, prohibiting a flow of gas to the vacuum piping, and adsorbing CO₂ in the atmosphere to the adsorbent, the desorption step sealing the adsorption chamber, permitting the flow of the gas to the vacuum piping, and desorbing CO₂ from the adsorbent. The controller further sets a target rotation speed of a motor that drives the vacuum pump, based on an amount of the water that has been adsorbed to the adsorbent, and controls the motor in accordance with the target rotation speed that has been set.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an example of a piping configuration of a DAC apparatus according to an embodiment of the present invention;

FIG. 2 is a time chart for describing changes in pressure of a reactor during a desorption step;

FIG. 3 is a block diagram schematically illustrating an example of a control configuration of the DAC apparatus;

FIG. 4 is a diagram for describing a characteristic indicating a relationship between a water level increase rate of a water tank in FIG. 1 and a target rotation speed of a motor that drives a vacuum pump; and

FIG. 5 is a flowchart illustrating an example of target rotation speed setting processing performed by a controller in FIG. 3.

### DETAILED DESCRIPTION OF THE INVENTION

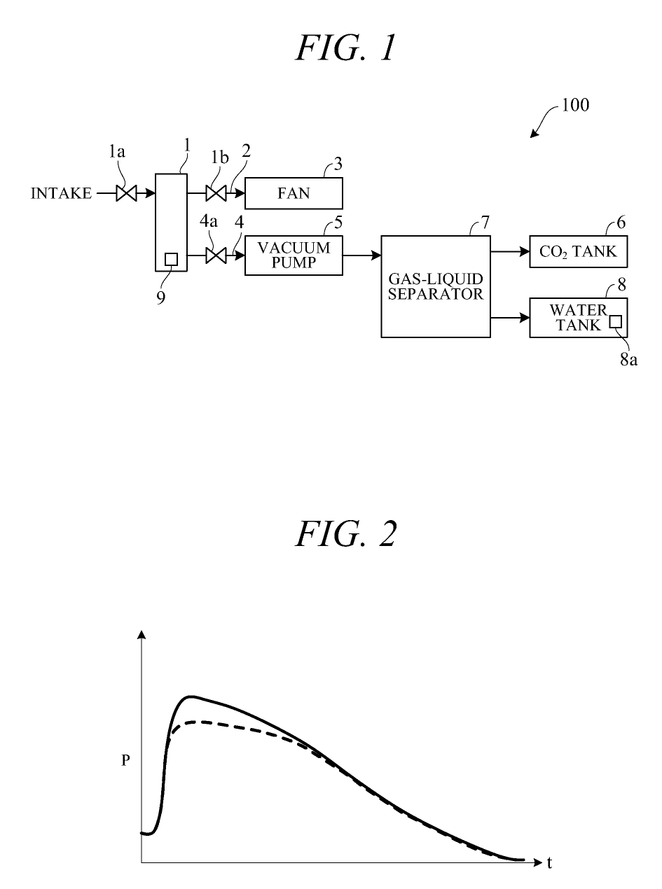

Hereinafter, embodiments of the present invention will be described with reference to FIGS. 1 to 5. FIG. 1 is a block diagram schematically illustrating an example of a piping configuration of a DAC apparatus 100 according to an embodiment of the present invention. As illustrated in FIG. 1, the DAC apparatus 100 mainly includes a reactor 1, in which an adsorbent for adsorbing or absorbing CO₂ is provided.

The reactor 1 includes a housing in which a sealed space (an adsorption chamber) can be formed, and the adsorbent is provided in the adsorption chamber of the reactor 1. As the adsorbent, a solid material constituted to adsorb CO₂ at normal temperature and normal pressure and to desorb CO₂ as the temperature rises can be used. For example, an amine-based solid absorbent in which an amine-based compound is carried on an appropriate carrier can be used. Such an adsorbent adsorbs or absorbs water in addition to CO₂. The adsorbent is constituted in an appropriate granular shape, is filled in a filter cartridge or the like having a mesh structure, for example, and is accommodated in the adsorption chamber of the reactor 1.

Atmospheric control valves 1a and 1b, each of which opens the reactor 1 to the atmosphere or seals the reactor 1 from the atmosphere, are provided for the reactor 1. The atmospheric control valves 1a and 1b may be provided on piping that connects the adsorption chamber of the reactor 1 with an external space, or may be provided as a part of a housing (a wall surface) of the reactor 1. When the atmospheric control valves 1a and 1b are open, the adsorption chamber of the reactor 1 is open to the atmosphere. When the atmospheric control valves 1a and 1b are closed, the adsorption chamber of the reactor 1 is sealed. The atmospheric control valve 1a and the atmospheric control valve 1b are provided to face each other with the adsorption chamber interposed between them.

A fan 3 for circulating the atmosphere into the adsorption chamber of the reactor 1 is connected with the reactor 1 through appropriate piping (atmospheric piping) 2 and one of the atmospheric control valves 1a and 1b (the atmospheric control valve 1b in the illustrated example). In the illustrated example, when the atmospheric control valves 1a and 1b are open and the fan 3 is driven, the atmosphere is taken into the reactor 1 through the atmospheric control valve 1a, and the atmosphere is exhausted from the reactor 1 through the atmospheric control valve 1b, the atmospheric piping 2, and the fan 3. Thus, when the atmosphere circulates into the reactor 1, CO₂ in the atmosphere is adsorbed to the adsorbent in the adsorption chamber (an adsorption step). The atmospheric control valves 1a and 1b and the atmospheric piping 2 are each configured to have a relatively large diameter so as to enable a large amount of atmosphere to circulate into the reactor 1. A plurality of the atmospheric control valves 1a and a plurality of the atmospheric control valves 1b may be provided.

Vacuum piping 4 is further connected with the reactor 1. The vacuum piping 4 connects the adsorption chamber of the reactor 1 with an intake port of a vacuum pump5 for CO₂ recovery. On the vacuum piping 4, a vacuum control valve 4a, which permits or prohibits a flow of gas in the vacuum piping 4, that is, the flow of gas from the reactor 1 to the vacuum piping 4, is provided. The vacuum control valve 4a may be made up of an on-off valve such as a ball valve, an adjustment valve such as a butterfly valve, or a combination of them. A CO₂ tank 6 is connected with an exhaust port of the vacuum pump 5 through appropriate piping.

A gas-liquid separator 7 is interposed between the vacuum pump 5 and the CO₂ tank 6. As the gas-liquid separator 7, for example, a condenser that cools gas using heat exchange and condenses water can be used. A water tank 8, which stores water that has been separated by the gas-liquid separator 7, is also connected with the gas-liquid separator 7. A water level sensor 8a, which detects a water level of the water tank 8, is provided in the water tank 8.

In the reactor 1, a heating device that heats the adsorbent and a cooling device that cools the adsorbent are also provided. For example, a heat exchanger 9, which heats or cools the adsorbent using the heat medium, is provided.

When the adsorption step ends, the atmospheric control valves 1a and 1b are closed, and in addition, the vacuum control valve 4a is opened. When the vacuum pump 5 is driven, the gas in the adsorption chamber of the reactor 1 is sucked out by the vacuum pump 5 through the vacuum piping 4. Thus, the inside of the adsorption chamber of the reactor R is deaerated (a deaeration step).

When the deaeration step ends, the atmospheric control valves 1a and 1b are closed, and in addition, the vacuum control valve 4a is opened. In a state in which the vacuum pump 5 is driven, the adsorbent starts to be heated by the heat exchanger 9. Thus, the pressure of the reactor 1 becomes lower than that at the time of adsorption, and in addition, the temperature of the adsorbent becomes higher than that at the time of adsorption. The CO₂ that has been adsorbed to the adsorbent and water are desorbed, and the desorption gas containing the desorbed CO₂ and water is sucked from the reactor 1. The desorption gas that has been sucked from the reactor 1 by the vacuum pump 5 is separated into gaseous CO₂ and liquid water by the gas-liquid separator 7, the gaseous CO₂ is stored and recovered in the CO₂ tank 6, and the liquid water is stored in the water tank 8 (a desorption step).

In heating the adsorbent in the desorption step, if the temperature of the adsorbent rises in a state in which oxygen is present in the adsorption chamber, the adsorbent may be subject to oxidation deterioration. By performing the deaeration step before the desorption step accompanied by the temperature rise of the adsorbent starts, and removing the residual atmosphere in the adsorption chamber containing oxygen, it becomes possible to prevent the oxidation deterioration of the adsorbent.

The deaeration step may be performed using the vacuum pump 5 for CO₂ recovery. However, a vacuum pump (a vacuum pump for deaeration) different from the vacuum pump 5 may be connected with the adsorption chamber of the reactor 1 through vacuum piping (vacuum piping for deaeration) different from the vacuum piping 4, and then the deaeration step may be performed using such a vacuum pump for deaeration. In this case, it is possible to exhaust the residual atmosphere that has been deaerated from the inside of the adsorption chamber of the reactor 1 through such a vacuum pump for deaeration without guiding the residual atmosphere to the CO₂ tank 6, so that the concentration of CO₂ recovered in the CO₂ tank 6 can be further increased.

After the desorption step ends and before the adsorption step starts, a cooling step of cooling the adsorbent in the adsorption chamber of the reactor 1 is performed. When the atmosphere containing oxygen circulates into the adsorption chamber in a state in which the adsorbent has a high temperature, the adsorbent may be subject to the oxidation deterioration. By performing the cooling step of cooling the adsorbent before the adsorption step of causing the atmosphere to circulate into the adsorption chamber, it becomes possible to prevent the oxidation deterioration of the adsorbent. In the cooling step, processing may wait until the temperature of the adsorbent decreases to fall within a temperature range in which an oxidation reaction does not proceed, but the adsorbent in the adsorption chamber may be cooled by the heat exchanger 9. In this case, the time necessary for the cooling step can be shortened, so that the DAC apparatus 100 can be efficiently operated.

FIG. 2 is a time chart for describing changes in pressure P of the reactor 1 during the desorption step, and illustrates the pressure (total pressure) P (a solid line) of the reactor 1 and the partial pressure of water (water vapor partial pressure) (a broken line). The pressure P of the reactor 1 is normal pressure (atmospheric pressure) during the adsorption step. When the deaeration step starts, the pressure P decreases to the predetermined pressure corresponding to the final ultimate pressure of the vacuum pump 5. That is, the pressure P of the reactor 1 during the deaeration step and the desorption step is a negative pressure lower than the atmospheric pressure, and the vacuum degree in the adsorption chamber increases as the pressure P in FIG. 2 decreases.

As illustrated in FIG. 2, the proportion of the water vapor partial pressure to the total pressure of the reactor 1 during the desorption step is extremely large, and the water vapor partial pressure occupies most of the total pressure. That is, the proportion of water (the water vapor) in the desorption gas is extremely large, and the water vapor occupies most of the desorption gas. The amount of the water vapor contained in the desorption gas corresponds to the amount of the water that has been adsorbed to the adsorbent in the adsorption step, and changes in accordance with environmental conditions including the temperature and the humidity (relative humidity) of the atmosphere that has been sucked into the reactor 1 in the adsorption step, that is, the outside air temperature and the outside air humidity. Therefore, in the present embodiment, the DAC apparatus 100 is configured as follows in such a manner that the vacuum pump 5 is controlled in consideration of the amount of the water that has been adsorbed to the adsorbent, so that the vacuum pump 5 for CO₂ recovery can be efficiently operated.

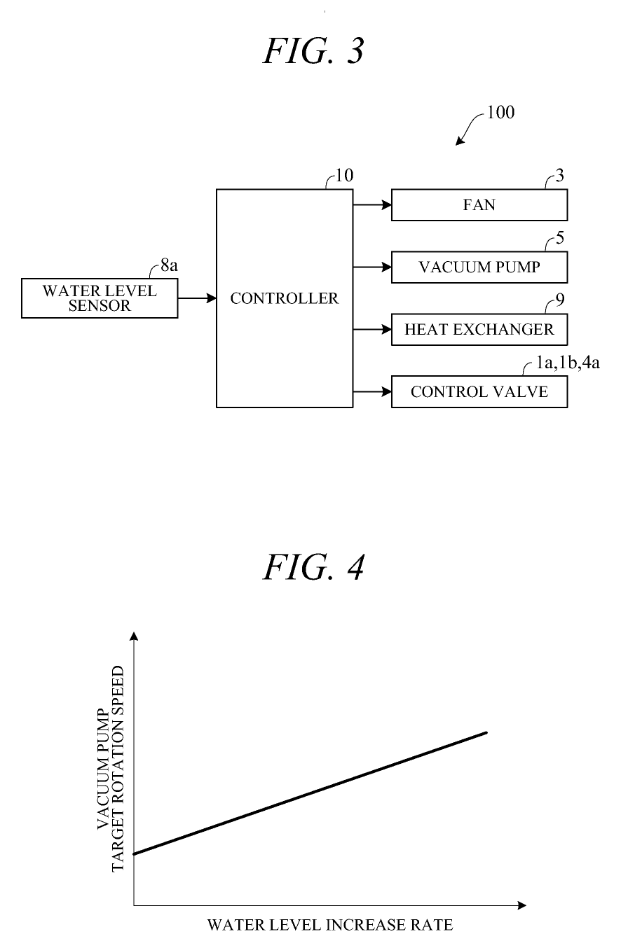

FIG. 3 is a block diagram schematically illustrating an example of a control configuration of the DAC apparatus 100. As illustrated in FIG. 3, the DAC apparatus 100 includes a controller 10, which controls each unit of the DAC apparatus 100 illustrated in FIG. 1. The controller 10 is made up of a computer including a CPU, a ROM, a RAM, an I/O interface, and other peripheral circuits. The water level sensor 8a is connected with the controller 10, and a signal indicating a detection value of the water level sensor 8a is input into the controller 10. In addition, the fan 3, the vacuum pump 5, the heat exchanger 9, and the control valves (the atmospheric control valves 1a and 1b and the vacuum control valve 4a) are included in the DAC apparatus 100, and each unit of the DAC apparatus 100 is connected with the controller 10. A control signal is transmitted from the controller 10 to each unit of the DAC apparatus 100.

The controller 10 drives the fan 3 and the vacuum pump 5 to start the heat exchanger 9, and then controls each unit of the DAC apparatus 100 in such a manner that the adsorption step and the desorption step are alternately performed in the reactor 1, and an operation cycle including the adsorption step and the desorption step is repeated. More specifically, in the adsorption step, the controller 10 opens the atmospheric control valves 1a and 1b to cause the atmosphere to circulate into the reactor 1, and also closes the vacuum control valve 4a to prohibit the flow of gas from the reactor 1 to the vacuum piping 4. In the deaeration step, the atmospheric control valves 1a and 1b are closed to seal the reactor 1, and in addition, the vacuum control valve 4a is open to permit the flow of gas from the reactor 1 to the vacuum piping 4. In the desorption step, in a state in which the atmospheric control valves 1a and 1b are closed to seal the reactor 1, and in addition, the vacuum control valve 4a is open to permit the flow of gas from the reactor 1 to the vacuum piping 4, the heat exchanger 9 is controlled to heat the adsorbent.

The controller 10 sets a target rotation speed of a motor that drives the vacuum pump 5, based on an increase rate (a water level increase rate) of the water level that has been detected by the water level sensor 8a and a predetermined characteristic, and controls the motor in accordance with the target rotation speed that has been set. The predetermined characteristic denotes a characteristic indicating a relationship between the water level increase rate that changes in accordance with the environmental condition and a corresponding optimum target rotation speed, is determined beforehand by experiment, and is stored in the controller 10 (the ROM).

The controller 10 calculates the water level increase rate corresponding to the amount of the water that has been adsorbed to the adsorbent in the predetermined number of operation cycles, based on the change in the water level that has been detected by the water level sensor 8a in the predetermined number of operation cycles. The predetermined number of operation cycles may be a predetermined number of operation cycles up to the previous time, or may be a first predetermined number of operation cycles after the DAC apparatus 100 is activated. In a case where the plurality of reactors 1 are provided in parallel with each other in the DAC apparatus 100, and the operation cycles are sequentially performed by shifting the timings of the plurality of reactors 1, a predetermined number of operation cycles performed earlier out of the plurality of reactors 1 or a first predetermined number of operation cycles may be set as the predetermined number of operation cycles.

FIG. 4 is a diagram for describing a characteristic indicating a relationship between the water level increase rate and the target rotation speed of the motor that drives the vacuum pump 5. As illustrated in FIG. 4, the target rotation speed is set to increase, as the amount of the water that has been adsorbed to the adsorbent increases and the water level increase rate increases. The load of the motor that drives the vacuum pump 5 increases as the amount of water vapor contained in the desorption gas increases, and decreases as the amount of water vapor contained in the desorption gas decreases. When the water level increase rate is large and the amount of the water vapor contained in the desorption gas is large, the target rotation speed is set to be high. When the water level increase rate is small and the amount of the water vapor contained in the desorption gas is small, the target rotation speed is set to be low. Thus, the operation efficiency of the vacuum pump 5 can be improved. That is, by setting an appropriate target rotation speed, based on the water level increase rate corresponding to the amount of the water vapor contained in the desorption gas, the operation efficiency of the vacuum pump 5 can be improved and the power consumption can be suppressed.

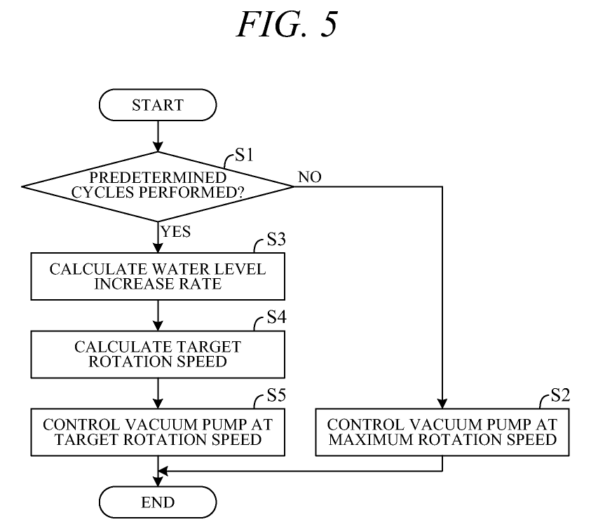

FIG. 5 is a flowchart illustrating an example of target rotation speed setting processing performed by the controller 10 in FIG. 3. As illustrated in FIG. 5, in S1 (S: processing step), the controller 10 determines whether a predetermined number of operation cycles are performed after the DAC apparatus 100 is activated. In a case where a negative determination is made in S1, the processing proceeds to S2. The target rotation speed of the motor for driving the vacuum pump 5 is set to a predetermined maximum rotation speed, and the motor for driving the vacuum pump 5 is controlled to reach the maximum rotation speed. In a case where an affirmative determination is made in S1, the processing proceeds to S3, and the water level increase rate is calculated, based on a change in the water level that has been detected by the water level sensor 8a in the predetermined number of operation cycles. Next, in S4, a target rotation speed corresponding to the water level increase rate calculated in S3 is calculated with reference to a predetermined characteristic (FIG. 4), and the motor for driving the vacuum pump 5 is controlled to have the calculated target rotation speed.

According to the embodiments of the present invention, the following operation and effects are achievable.

(1) The DAC apparatus 100 includes: the reactor 1 in which an adsorbent for adsorbing or absorbing CO₂ and water is provided; the atmospheric control valves 1a and 1b, which open the reactor 1 to atmosphere or seal the reactor 1 from the atmosphere; the vacuum pump 5 including an intake port connected with the reactor 1 through the vacuum piping 4; the vacuum control valve 4a provided on the vacuum piping 4; and the controller 10 configured to control the atmospheric control valves 1a and 1b and the vacuum control valve 4a to alternately perform an adsorption step and a desorption step, the adsorption step opening the reactor 1 to the atmosphere, prohibiting a flow of gas to the vacuum piping 4, and adsorbing CO₂ in the atmosphere to the adsorbent, the desorption step sealing the reactor 1, permitting the flow of the gas to the vacuum piping 4, and desorbing CO₂ from the adsorbent (FIGS. 1 and 3).

The controller 10 further sets a target rotation speed of the motor that drives the vacuum pump 5, based on the amount of the water that has been adsorbed to the adsorbent, and controls the motor in accordance with the target rotation speed that has been set (FIG. 5). In this manner, by controlling the vacuum pump 5 in consideration of the amount of the water that has been adsorbed to the adsorbent, the vacuum pump 5 for CO₂ recovery can be efficiently operated.

(2) The DAC apparatus 100 further includes: the CO₂ tank 6, which is connected with an exhaust port of the vacuum pump 5, and which stores CO₂ that has been recovered; the gas-liquid separator 7 interposed between the vacuum pump 5 and the CO₂ tank 6; the water tank 8, which stores water that has been separated by the gas-liquid separator 7; and the water level sensor 8a, which detects a water level of the water tank 8 (FIGS. 1 and 3). The controller 10 sets the target rotation speed, based on the water level increase rate that has been detected by the water level sensor 8a. Thus, it becomes possible to estimate the amount of water that has been adsorbed to the adsorbent with ease and with accuracy, and to set an appropriate target rotation speed of the motor that drives the vacuum pump 5.

(3) The controller 10 sets the target rotation speed, based on a predetermined characteristic indicating a relationship between the water level increase rate and the target rotation speed (FIG. 4). The target rotation speed is set to increase, as the amount of the water that has been adsorbed to the adsorbent increases and the water level increase rate increases. In this manner, the characteristic indicating the relationship between the water level increase rate and the target rotation speed is determined beforehand, so that an appropriate target rotation speed can be set with ease and with accuracy.

(4) The controller 10 controls the atmospheric control valves 1a and 1b and the vacuum control valve 4a to repeat an operation cycle including the adsorption step and the desorption step, and sets the target rotation speed, based on the amount of the water that has been adsorbed to the adsorbent in a predetermined number of operation cycles (FIG. 5). The load of the motor that drives the vacuum pump 5 changes as the amount of water vapor contained in the desorption gas changes in accordance with the environmental condition. In consideration of the amount of the water that has been separated from the desorption gas in the actual operation cycle, it becomes possible to set the appropriate target rotation speed in accordance with the actual environmental condition with ease and with accuracy.

In the above embodiment, an example has been described in which the water level sensor 8a is provided in the water tank 8 to detect the water level, and the target rotation speed of the motor that drives the vacuum pump 5 is set, based on the increase rate of the water level (the water level increase rate) that has been detected by the water level sensor 8a as a physical quantity corresponding to the amount of the water that has been adsorbed to the adsorbent in FIG. 1 and the like. However, the physical quantity corresponding to the amount of the water that has been adsorbed to the adsorbent is not limited to the water level. For example, a weight sensor may be provided in the water tank 8 to detect the weight of the water stored in the water tank 8, and the target rotation speed of the motor that drives the vacuum pump 5 may be set, based on an increase rate of the weight of the water that has been detected by the weight sensor as the physical quantity corresponding to the amount of the water that has been adsorbed to the adsorbent. Alternatively, a flow rate sensor may be provided at an inlet of the water tank 8 to detect the inflow amount of water into the water tank 8, and the target rotation speed of the motor that drives the vacuum pump 5 may be set, based on an increase rate of the inflow amount of the water that has been detected by the flow rate sensor as the physical quantity corresponding to the amount of the water that has been adsorbed to the adsorbent.

The above embodiment can be combined as desired with one or more of the aforesaid modifications. The modifications can also be combined with one another.

According to the present invention, it becomes possible to efficiently operate the vacuum pump for CO₂ recovery.

Above, while the present invention has been described with reference to the preferred embodiments thereof, it will be understood, by those skilled in the art, that various changes and modifications may be made thereto without departing from the scope of the appended claims.

1. A DAC apparatus configured to recover CO₂ in the atmosphere, comprising:
an adsorption chamber provided with an adsorbent for adsorbing or absorbing CO₂ and water;
an atmospheric control valve configured to open the adsorption chamber to the atmosphere or seal the adsorption chamber from the atmosphere;
a vacuum pump including an intake port connected with the adsorption chamber through a vacuum piping;
a vacuum control valve provided on the vacuum piping; and
a controller configured to control the atmospheric control valve and the vacuum control valve to alternately perform an adsorption step and a desorption step, the adsorption step opening the adsorption chamber to the atmosphere, prohibiting a flow of gas to the vacuum piping, and adsorbing CO₂ in the atmosphere to the adsorbent, the desorption step sealing the adsorption chamber, permitting the flow of the gas to the vacuum piping, and desorbing CO₂ from the adsorbent, wherein
the controller further sets a target rotation speed of a motor that drives the vacuum pump, based on an amount of the water that has been adsorbed to the adsorbent, and controls the motor in accordance with the target rotation speed that has been set.

2. The DAC apparatus according to claim 1, further comprising:
a CO₂ tank connected with an exhaust port of the vacuum pump, and configured to store recovered CO₂;
a gas-liquid separator interposed between the vacuum pump and the CO₂ tank;
a water tank configured to store the water that has been separated by the gas-liquid separator; and
a water level sensor configured to detect a water level of the water tank, wherein
the controller sets the target rotation speed, based on a water level increase rate that has been detected by the water level sensor.

3. The DAC apparatus according to claim 2, wherein
the controller sets the target rotation speed, based on a predetermined characteristic indicating a relationship between the water level increase rate and the target rotation speed.

4. The DAC apparatus according to claim 1, wherein
the target rotation speed is set to increase, as the amount of the water that has been adsorbed to the adsorbent increases.

5. The DAC apparatus according to claim 1, wherein
the controller controls the atmospheric control valve and the vacuum control valve to repeat an operation cycle including the adsorption step and the desorption step, and sets the target rotation speed, based on the amount of the water that has been adsorbed to the adsorbent in a predetermined number of operation cycles.
